(19) United States
(12) Patent Application Publication
(10) Pub. No.: US 2019/0337135 A1
(43) Pub. Date: Nov. 7, 2019

(54) Fastening Device

(71) Applicant: Klein Tools, Inc., Lincolnshire, IL (US)

(72) Inventors: John H. Kargenian, Prospect Heights, IL (US); Zachary Carlins, Chicago, IL (US)

(73) Assignee: Klein Tools, Inc., Lincolnshire, IL (US)

(21) Appl. No.: 16/405,381

(22) Filed: May 7, 2019

Related U.S. Application Data
(60) Provisional application No. 62/667,678, filed on May 7, 2018.

(51) Int. Cl. B25C 5/15; B25C 5/06; B25C 5/16

(52) U.S. Cl. CPC B25C 5/15; F16B 15/0015; B25C 5/1606; B25C 5/06

(57) ABSTRACT

Electrically powered fastening devices configured to drive staples suited to multiple applications. The fastening device includes an adjustable feeder and depth gauge, a hammer device with a mechanism for translating rotary power to linear striking force, and a staple guide configured to drive staples with selected, specialized profiles and configured with inner radii sized and shaped to conform to particular wire and sheathing diameters.

### CROSS-REFERENCE TO RELATED APPLICATIONS

This patent application claims the benefit of U.S. Provisional Patent Application No. 62/667,678, filed May 7, 2018, which is incorporated by reference herein in its entirety.

### FIELD OF THE DISCLOSURE

The disclosure relates to tools, and, more particularly, to tools for driving staples or similar fasteners.

### BACKGROUND OF THE DISCLOSURE

The present disclosure relates to the field of fastening mechanisms including powered fastening devices, and particularly the field of battery-powered heavy-duty utility fastening. Such devices are moderately lightweight and suitable for portable operation. Various types of such fastening devices are commonly used in several industries, powered in a wide variety of ways, including gas-powered, hydraulically, pneumatically, or through the use of an electrical solenoid to concentrate force onto a particular striking member and drive a fastener into the target medium. In the simplest of such devices, a single driving stroke is delivered to the fastener to drive it into comparatively soft materials, but in the field of heavy-duty utility fastening, multiple strikes are typically required to perform the desired task. Accordingly, the concept of a multiple-strike electrically powered fastening device is well known in the prior art.

Powered fastening devices are commonly used by homeowners and contractors and are chiefly designed to drive standardized light fasteners into untreated wood. In the electrical utility field, it is common for typical users of powered fastening devices to affix cables or wires with large staples to utility poles and other structural members of an electrical distribution system, often in remote locations where standard 110-volt power sources are unavailable. Currently, the preferred method of accomplishing this task is to use a common hammer to drive U-shaped nails or staples into these structural members. The use of a hammer to strike the rounded strike surface of typical stapling fasteners in the prior art is prone to being misfit or deformed by the fastening device, potentially causing damage or inaccurate fastening. There exists in this field a need for fastening devices and stapling fasteners better suited to these tasks.

A typical powered fastening device in the prior art is designed to aggressively drive a fastener into a medium as deep and as quickly as possible, usually in a single stroke, however this is disadvantageous in some applications, including electrical utility work. In these applications, a heavy duty stapling fastener is used to affix and guide a delicate elongated object, such as a wire or a wire chase, to a working surface, and excessive force may damage or sever the wire or wire chase. An inaccurate insulation can also cause bowing or bending of the wire or wire chase, requiring the removal and reinstallation of the stapling fastener.

Additionally, many modern utility poles and other structural members found in the power utility trade are hardened, which may requiring more strokes than current standard battery operated fastening devices provide to drive large stapling fasteners. Accordingly, a multiple-strike electrically powered fastening device is preferable for this application to incrementally, but rapidly, drive a stapling fastener into a utility pole.

The present disclosure addresses all of the shortcomings of prior battery operated fastening devices noted above.

### BRIEF SUMMARY OF THE DISCLOSURE

In accordance with the present disclosure, a fastening device is described which is adapted to draw power from a power source, preferably a rechargeable battery, and convert and transfer energy from the power source to drive a fastener, such as a specialized stapling fastener, into, for example, a hardened working surface, such as a utility pole, in a manner suitable for affixing to the working surface certain destructible items, such as wires and wire chases. A motor is employed to convert electrical energy to kinetic energy, and a potential energy storing device is employed to store energy that is converted to kinetic energy during operation. The energy is released abruptly and strikes an anvil and a drive pin, which then strikes the stapling fastener. In order to preserve the integrity of the destructible items, the kinetic energy storing device of the present disclosure provides a forceful strike over a much shorter travel distance, and a depth control mechanism is employed to limit the reach of the drive pin to prevent the driven fastener from being fully driven into the working surface.

In order to prevent damage to destructible workpieces, such as wires or wire chases, the present disclosure incorporates a nozzle tip designed to accommodate a stapling fastener while simultaneously fixing the location of the workpiece. To further protect and secure the destructible items, embodiments of a modified stapling fastener are disclosed. Features of the stapling fastener can include an interior cutout conforming to a wire, an interior profile conforming to a wire chase, a broad-headed striking area to maximize contact between the fastener and a drive pin, where this striking area is parallel to the end of the driving pin to ensure perpendicular placement of the stapling fastener into a working surface.

Combinations of these improvements provides for a device well-suited to the needs of an electrical utility lineman and other possible professions.

### BRIEF DESCRIPTION OF THE SEVERAL VIEWS OF THE DRAWING(S)

FIG. 1 is a side view of one embodiment of the disclosure.

FIG. 2 is a cutaway view revealing the interior components of the device shown in FIG. 1.

FIG. 3 is an assembly view of one embodiment of a percussive assembly and drive pin assembly of the device shown in FIG. 1.

FIG. 4 is a cross sectional view of the percussive assembly shown in FIG. 3.

FIG. 5 is a perspective view of the hammer disk in the percussive assembly show in FIG. 3.

FIG. 6 is a cross sectional view of the hammer disk shown in FIG. 5.

FIG. 7 is a cross sectional view of the gearbox of the percussive assembly shown in FIG. 3.

FIG. 8 is a side view of the drive shaft of the percussive assembly shown in FIG. 3.

FIG. 9 is an alternate side view of the drive shaft shown in FIG. 8.

FIG. 10 is a top view of the percussive assembly and a cross sectional top view of the drive pin assembly shown in FIG. 3.

FIG. 11 is a side view of the percussive assembly and drive pin assembly shown in FIG. 3.

FIGS. 12A and 12B are top views of an alternative embodiment of the percussive assembly and drive pin assembly shown in FIG. 3.

FIG. 13 is a side view of an embodiment of a feeder assembly of the device in FIG. 1 in a starting configuration.

FIG. 14 is a side view of the feeder assembly of FIG. 13 in a middle configuration.

FIG. 15 is a side view of the feeder assembly of FIG. 13 in an ending configuration.

FIG. 16 is a close-up view of the feeder stop assembly of the device in FIG. 13.

FIG. 17 is a side view of the feeder assembly of FIG. 13 at maximum depth setting in an ending configuration.

FIG. 18 is a side view of the feeder assembly of FIG. 13 at minimum depth setting in an ending configuration.

FIG. 19 is a front view of a heavy-duty stapling fastener for use with device of FIG. 1.

FIG. 20 is a front view of the fastener in FIG. 19 when used with a wire.

FIG. 21 is a perspective view of the fastener and wire of FIG. 20.

FIG. 22 is a perspective view of the fastener in FIG. 18 when used with wire chase.

FIG. 23 is a front view of the fastener and wire chase of FIG. 22.

FIG. 24 is a front view of an alternative embodiment of a heavy-duty stapling fastener for use with the device of FIG. 1.

### DETAILED DESCRIPTION OF PREFERRED EMBODIMENT(S)

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims. The terms configured and configuration as used herein refer to specific structural sizes and shapes.

The exemplary embodiments described herein in accordance with the disclosure are applicable to battery operated fastening devices that are suitable for use with heavy-duty utility stapling fasteners through the systems and method in accordance with the disclosure, but may be applicable to many types of fastening devices in a multitude of applications.

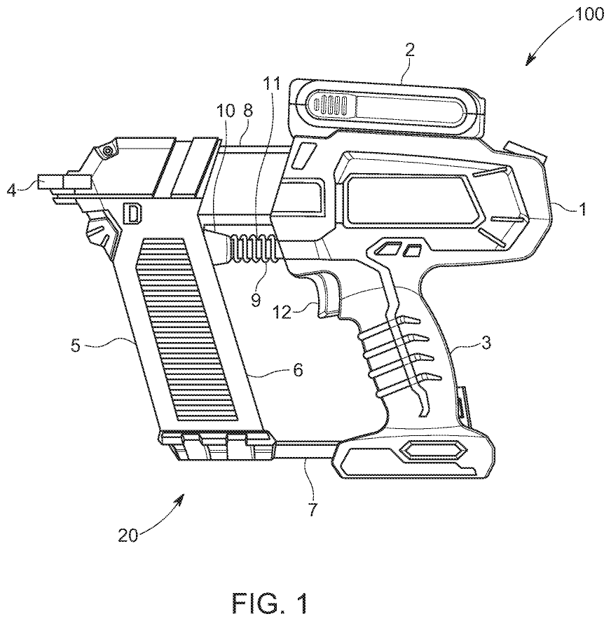

FIG. 1 depicts some general structures of the present disclosure: a fastening device 100 featuring a detachable battery pack 2, a main housing 1 including a grip handle 3, a feeder assembly 5 including a fastener magazine 22, and a fastening nozzle 4 configured to receive heavy-duty stapling fasteners 6. The housing 1 may be any suitable material including plastic, composite materials, and/or metal.

The detachable battery pack 2 in this example is a lithium-ion battery pack typical in the field of power fastening devices. Any suitable source of electricity is contemplated.

The feeder assembly 5 slides freely along a top rail 8 and a bottom rail 7 such that the feeder assembly 5 can be pushed back against the housing 1 when force is applied by a user to the back of the grip handle 3, which presses the nozzle 4 against a working surface. A return post 11 featuring a tapered stop 10 held back by a return spring 9 biases the feeder assembly 5 into its standby position 53 at its furthest possible point from the housing 1 when the fastening device 100 is not in use.

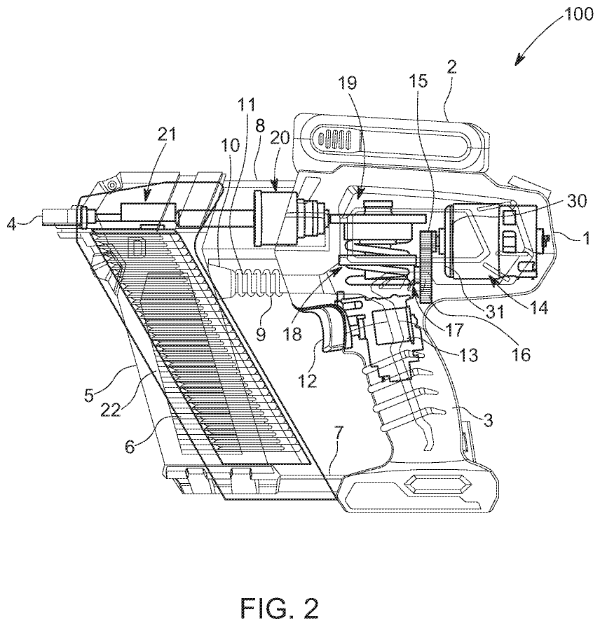

FIG. 2 depicts the embodiment of the disclosure shown in FIG. 1 with interior mechanisms visible. A trigger 12 is disposed near the top end of the grip handle 3. As long as the feeder assembly 5 is not in its standby position 53, when the trigger 12 is depressed, it engages a power switching mechanism 13, which in turn allows power from the detachable battery pack 2 to actuate an electric motor 14.

The electric motor 14 is mounted inside the housing 1 and is electrically connected to and powered by the removable battery pack 2 when the feeder assembly 5 is not in its standby position 53 and the trigger 12 is depressed. An output gear 15 of the electric motor 14 is rotated about the motor's axis 30 and interfaces with a drive gear 16 which itself is coupled to a first beveled gear 17. A second beveled gear 18 meshes with the first beveled gear 17 transferring the rotation to a working axis 31 of a percussive assembly 19, the particulars of which are detailed later in this disclosure. Any suitable power transmission mechanism or assembly is contemplated.

The percussive assembly 19 rotates at high speed and strikes at regular intervals a drive pin assembly 20, which is also detailed later in this disclosure. With each strike on the drive pin assembly 20 from the percussive assembly 19, a heavy-duty stapling fastener 6 in a fastening chamber 21 is driven with great force toward the fastening nozzle 4 and ejected out of the fastening device 100 and into whatever working surface is present.

When the feeder assembly 5 of the fastening device 100 is returned to its standby position 53 and the drive pin 37 retracts, a new heavy-duty stapling fastener 6 is advanced into the empty fastening chamber 21, and the fastening device 100 is readied to perform a new fastening cycle.

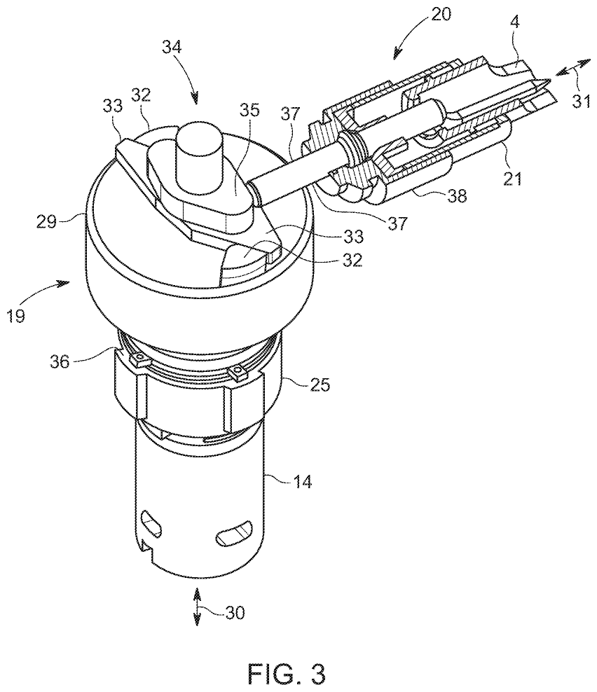

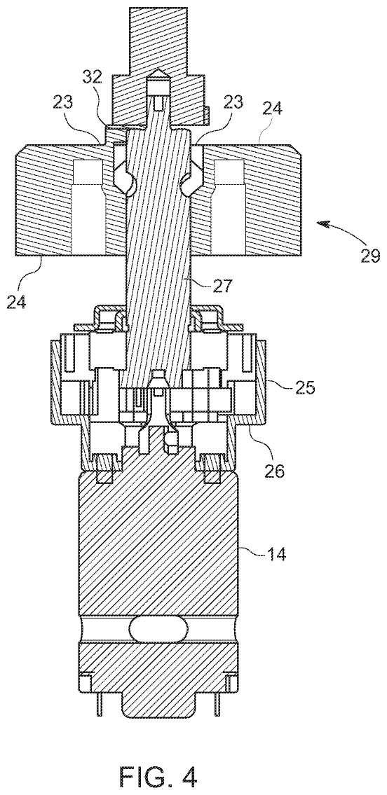

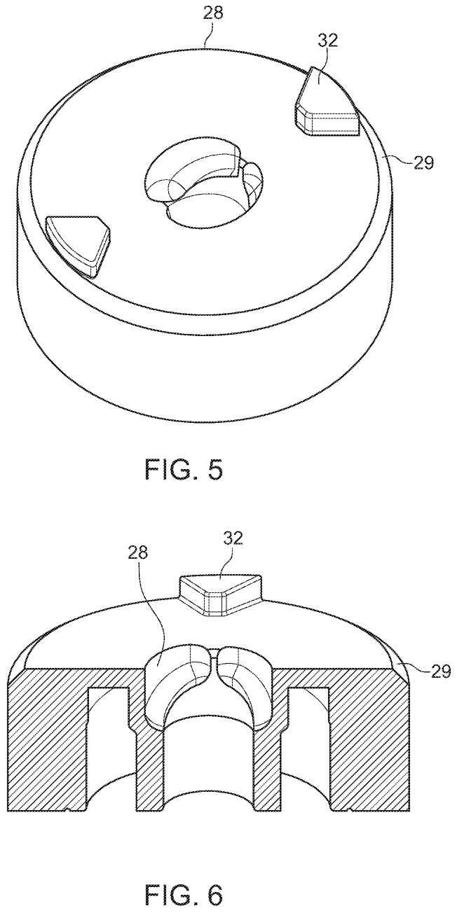

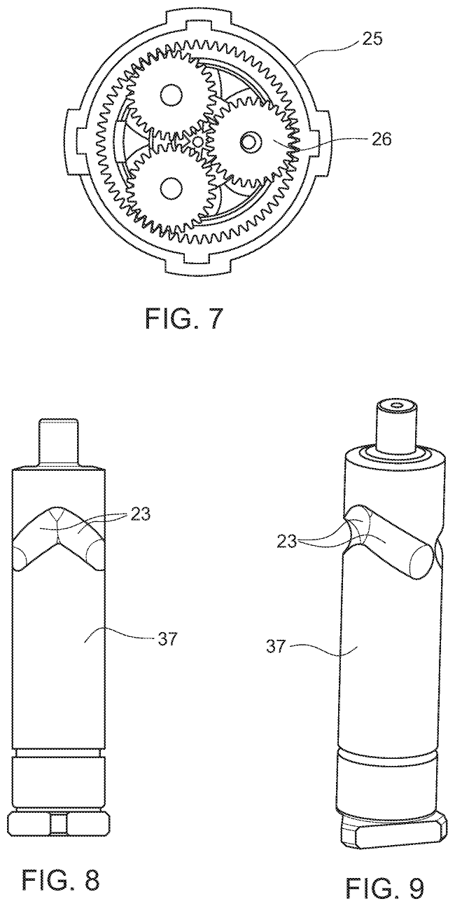

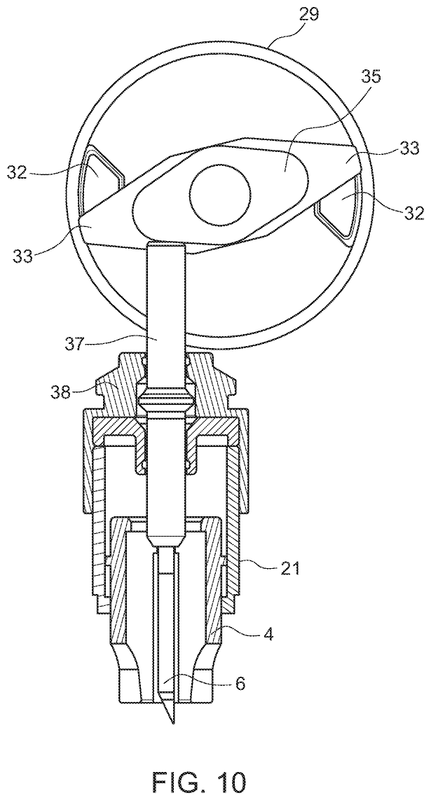

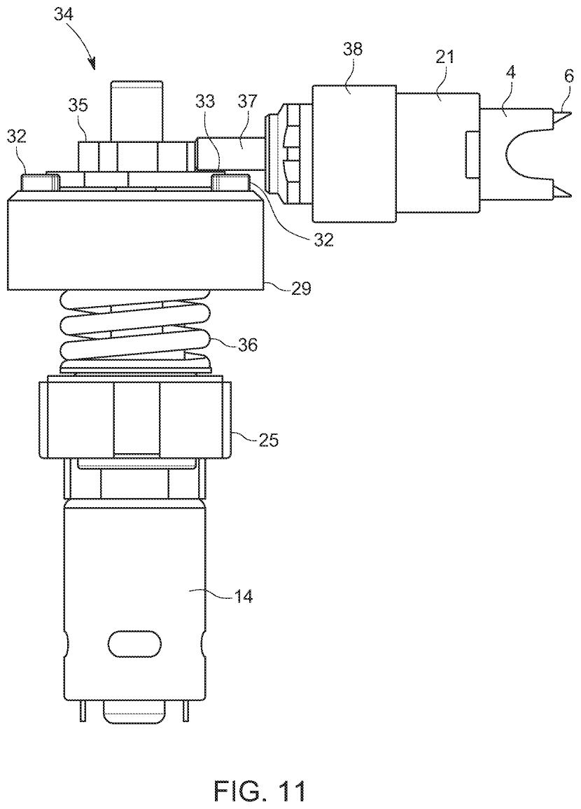

FIGS. 3-11 depict an embodiment of the percussive assembly 19 and the drive pin assembly 20, which may be mounted in-line with the electric motor 14. In this embodiment, the motor 14 is connected to a reduction gearbox 25 containing a planetary gear set 26, which in turn rotates a drive shaft 27 at a reduced rate of speed. The drive shaft 27 features two interior bearing ramps 23 which abut ball bearings 24 also bounded by two exterior bearing ramps 28 in the interior of a sufficiently weighty hammer disk 29.

Rotational motion of the hammer disk 29 is initially impeded by contact between two hammer nubs 32 on the hammer disk 29, which impinge upon a pair of anvil stops 33 on an anvil element 34. An anvil 35 is disposed on the anvil element 34 and is fixed with respect to the anvil stops 33, such that the anvil 35 is in contact with the drive pin assembly 20. The rotational energy transferred from the electric motor 14 through the gearbox 25, the drive shaft 27, and the bearings 24 cannot rotate the hammer disk 29 while the anvil stops 33 impede the hammer nubs 32, forcing the hammer disk 29 back toward the electric motor 14 as a function of the interior bearing ramps 23 and exterior bearing ramps 28, and storing energy in a heavy hammer spring 36.

When the hammer disk 29 has been pulled sufficiently closer to the electric motor 14 for the hammer nubs 32 to pass under the anvil stops 33, the energy stored in the hammer spring 36 is released. The energy stored in the hammer spring 36 is transferred to the hammer disk 29 via the ball bearings 24 in the interior bearing ramps 23 and the exterior bearing ramps 28 rotating the hammer disk 29 violently until the hammer nubs 32 again contact the anvil stops 33 with great force. This force is transferred through the anvil stops 33 to the entire anvil element 34 and thus to the anvil 35, which strikes the drive pin assembly 20 with great force.

One embodiment of the drive pin assembly 20 includes a drive pin 37 within a drive pin housing 38 which itself encloses a fastener chamber 21 and a fastening nozzle 4. The fastening nozzle 4 roughly corresponds to the contours of the heavy-duty stapling fastener 6, and is biased away from the fastener chamber 21 by a fastening chamber spring (not pictured). In this way, the fastening nozzle 4 holds the heavy-duty stapling fastener 6 in place while the fastening device 100 is in use. In addition, the fastening nozzle 4 may incorporate a wire cutout that is sized and shaped to accommodate a wire or wire chase and hold it in place during the fastening process without damaging the integrity of the wire or wire chase.

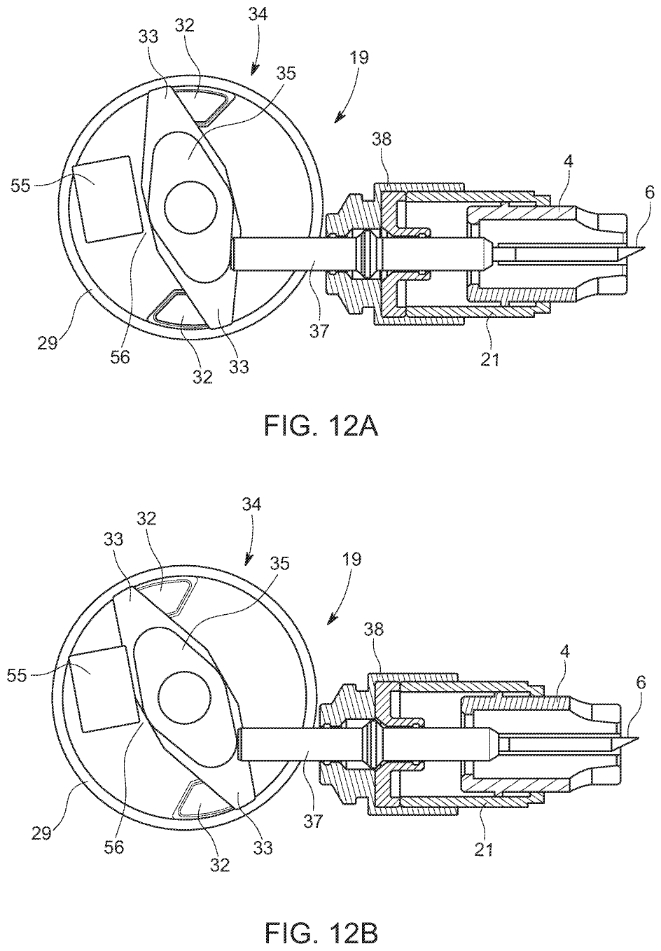

In FIG. 12, a bumper block 55 has been added to the percussive assembly 19 to limit the angular distance that the anvil element 34 can travel. This bumper block 55 abuts the anvil 35 on its non-striking side and prevents it from overdriving the drive pin 37, which reduces wear on the drive pin housing 38. A resilient bumper pad 56 on the bumper block 55 cushions the anvil 35 slowing it to prevent damage to the entire assembly. Because the anvil 35 strikes the drive pin 37 before it strikes the bumper pad 56, ordinarily the force imparted by the hammer disk 29 onto the anvil element 34 is fully transferred through the drive pin 37 and into the heavy-duty stapling fastener 6. The presence of the bumper block 55 and bumper pad 56 do not limit the impact force of the anvil 35 upon the drive pin 37 but rather serve to decelerate the anvil 35 after it has impacted the drive pin 37 if that force is for some reason not fully dissipated, perhaps because no fastener is located in the fastener receptacle 4. An added benefit of the bumper block 55 is that it can be used to increase the maximum force with which the anvil element 34 can resist the torque transferred by the anvil stops 33, potentially increasing the amount of force that can be stored in the hammer disk 29 when it is being loaded, resulting in a more powerful strike upon the drive pin 37.

The bumper block 55 also allows the hammer spring 36 to compress without requiring the user to push the drive pin 37 against the anvil 35, which in turn allows a more powerful hammer spring 36 to be used because the user's strength is not a limiting factor. Without the bumper block 55 the user must push device's nozzle 4 forward to push the drive pin 37 back against the anvil 35 to get the full force of the strike on the drive pin 37, otherwise the drive pin 37 will be farther out and compress the hammer spring 36 less before its energy is released.

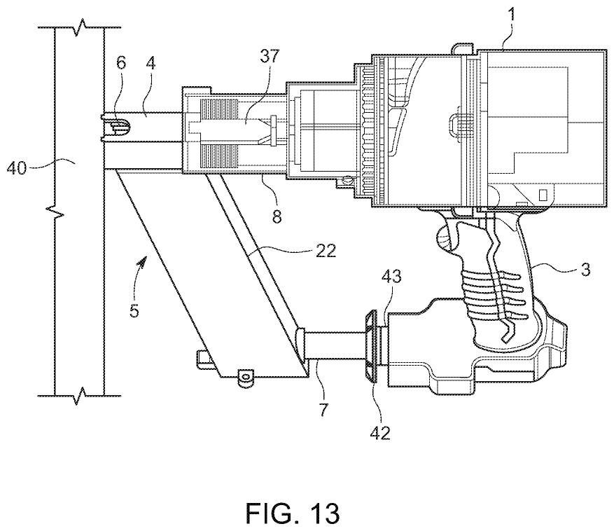

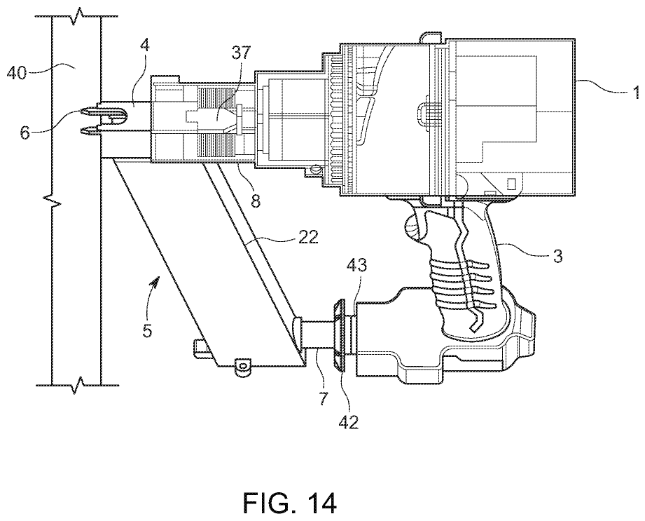

FIGS. 13-18 depict the functioning of an embodiment of a feeder assembly 5 of the fastening device 100. FIG. 13 depicts the fastening device 100 at the beginning of an operation, with a heavy-duty stapling fastener 6 positioned in the fastening nozzle 4 and the nozzle 4 of the device 100 abutting a working surface 40. As the fastening 100 device is actuated by depressing the trigger 12, the heavy-duty stapling fastener 6 is driven into the working surface 40, and the feeder assembly 5 retracts to allow the fastening device 100 to move forward and continually strike the heavy-duty stapling fastener 6 with each successive stroke of the drive pin 37, leading to the configuration shown in FIG. 14.

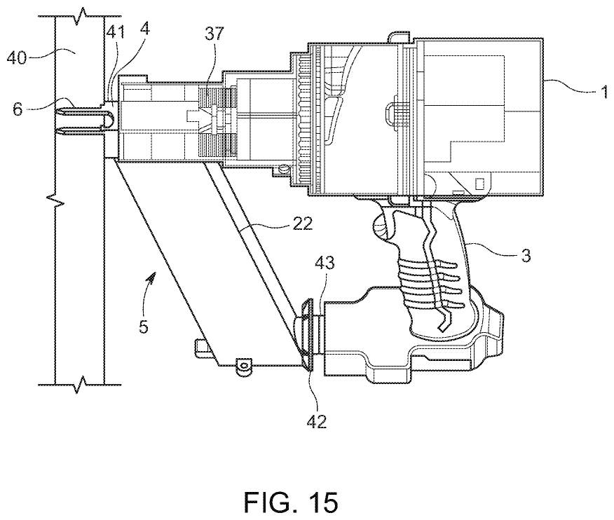

FIG. 15 depicts the fastening device 100 at the end of a fastening operation. In this view, the feeder assembly 5 can no longer advance, as it has reached the feeder assembly stop 39, which blocks its progress. Accordingly, the drive pin 37 can no longer reach heavy-duty stapling fastener 6 to drive it further into the working surface 40. A gap 41 is left between the interior of the heavy-duty stapling fastener 6 and the working surface 40, through which a wire, wire chase, or other object may be threaded or may have been previously placed against the work surface 40 prior to fastening. The heavy-duty stapling fastener 6 may be further or completely driven into the work surface 40, if desired, by adjusting the feeder assembly stop 39 to its maximum setting.

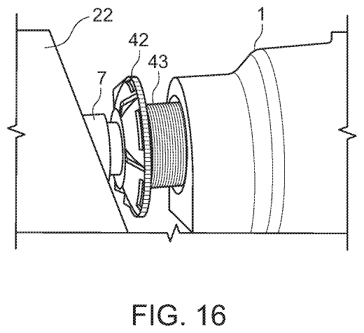

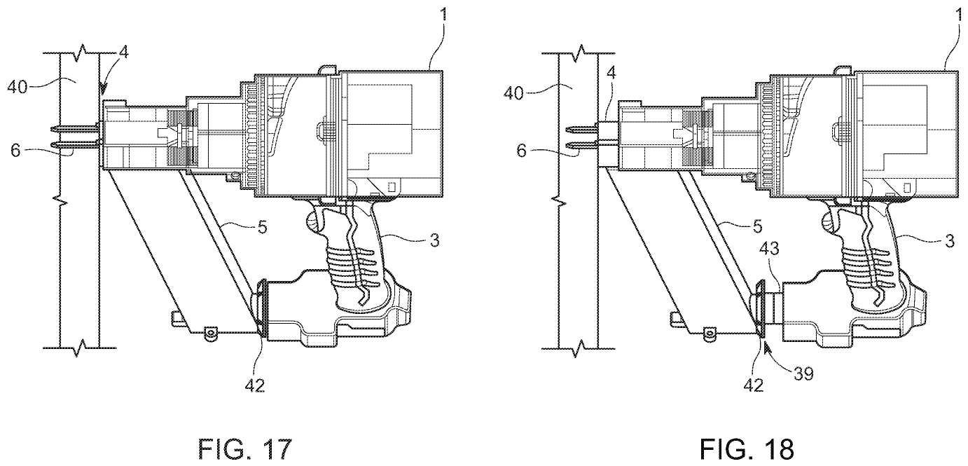

FIG. 16 details the feeder assembly stop 39, which is comprised of a rotatable selection knob 42 disposed around the bottom rail 7 and threading 43 into the housing 1 near the lower end of the grip handle 3. Rotating the selection knob 42 in one direction causes the threading 43 to advance into the housing 1, increasing the range of the feeder assembly 5 allowing the drive pin 37 to drive the heavy-duty stapling fastener 6 farther into the working surface 40, as seen in FIG. 17. Rotating the selection knob 42 in the other direction causes the threading 43 to retract from the housing 1, limiting the range of the feeder assembly 5 and preventing the drive pin 37 from striking the heavy-duty stapling fastener 6 further into the working surface 40, as seen in FIG. 18.

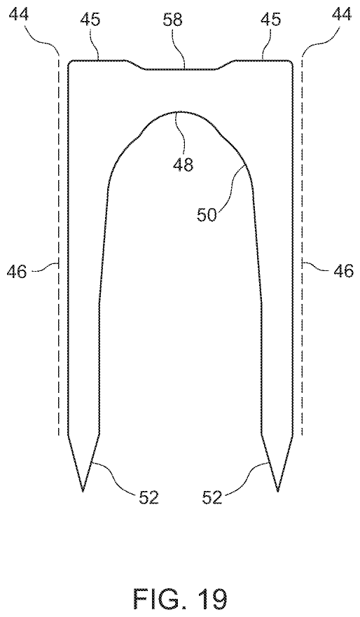

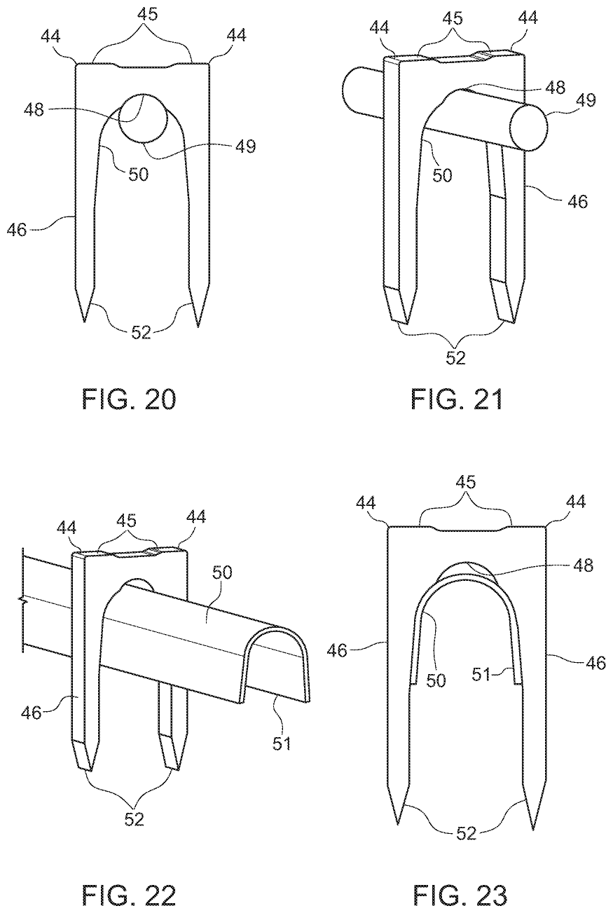

FIGS. 19-24 depict embodiments of a heavy-duty stapling fastener 6 itself. The striking surfaces or crown 45 of the heavy-duty stapling fastener 6 may be oriented parallel to the plane of the working surface 40 to maximize the force transferred from the drive pin 37 of the fastening device 100. The exterior sidewalls 46 of the heavy-duty stapling fastener 6 may be straight and parallel to each other to allow for proper orientation within the fastener chamber 21 and allowing the heavy-duty stapling fastener 6 to be more easily driven into the working surface 40 perpendicularly.

The corners 44 of the heavy-duty stapling fastener 6 may be squared to prevent errors in striking either with the fastening device 100 or with a traditional hammer. As a result of the corner configuration, the striking surfaces 45 of the heavy-duty stapling fastener 6 receive kinetic energy from the drive pin 37 more directly than a standard stapling fastener, producing a more powerful strike and preventing deformation of the heavy-duty stapling fastener 6. A depression 58 ensures that the striking forces on the striking surfaces 45 are concentrated directly over the tips 52 of the heavy-duty stapling fastener 6, which are beveled to a point, further allowing for ease of penetration of the heavy-duty stapling fastener 6 perpendicular into the working surface 40 and balancing the heavy-duty stapling fastener 6 with each strike of the drive pin 37. The exterior sidewalls 46 and interior sidewalls 54 of the heavy-duty stapling fastener 6 are straight and perpendicular to the plane of the workpiece allowing for easier penetration into the workpiece.

The interior contoured surface 47 of the heavy-duty stapling fastener 6 may be contoured specifically for work done by electrical utility linemen. A small radius 48 is formed within the interior contoured surface 47 near the top of the heavy-duty stapling fastener 6 in a size and shape to accommodate a wire 49. A large radius 50 may be formed adjacent and around the small radius 48 that is sized and shaped to accommodate a wire or wire chase 51 of a relatively larger diameter. The small radius 48 and large radius 50 need not be circular, and in the case of the wire chase 51, may be more parabolic in geometry.

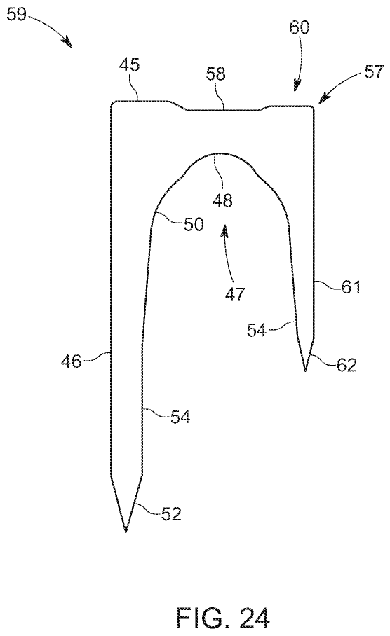

FIG. 24 depicts a modified heavy-duty stapling fastener 57 designed for affixing wires 49 and wire chases 51 to a working surface 40. This modified heavy-duty stapling fastener 57 retains many of the features of the heavy-duty stapling fastener 6, notably the striking surface 45, the corner 44, the exterior sidewall 46, the tip 52, the interior surface 47 on the driving side 59 of the modified heavy-duty stapling fastener 57. The small radius 48 and large radius 50 may remain as well. However, half of the modified heavy-duty stapling fastener 57 is an anchor side, consisting of a much shorter anchor arm 61 terminating in a less prominent anchor tip 62 long before the anchor tip 62, resulting in a significant reduction in force required to drive the modified heavy-duty stapling fastener 57 into the working surface 40.

The depression 58 can be extended over the anchor arm 61, ensuring that the full force of the drive pin 37 of the fastening device 100 will be transferred to the driving side 59 of the modified heavy-duty stapling fastener 57, or alternately an anchor side striking surface 60 may be raised above the height of the depression 58 but not quite as high as the striking surface 45 of the driving side 59. In this way, when the anchor side anchor tip 62 contacts the working surface 40, the modified heavy-duty stapling fastener 57 may rotate around the beveled tip 52, bringing the anchor side striking surface 60 closer to the drive pin 37 which may then strike it and balance the fastener 57 back toward the perpendicular. Accordingly the tip 52 of modified heavy-duty stapling fastener 57 will be driven into a working surface 40. After the anchor tip 62 is driven into the working surface 40, the small radius 48 will adequately house a wire 49, and the large radius 50 will adequately locate a wire chase 51.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the disclosure (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A powered fastening device comprising:
a housing;
a fastener drive assembly carried in the housing to drive a fastener into a work surface along a drive axis;
a drive motor carried in the housing and operably connected to the fastener drive assembly to actuate the fastener drive assembly;
a feeder assembly configured to carry a plurality of fasteners and to sequentially position each fastener of the plurality of fasteners relative to the fastener drive assembly to be driven by the fastener drive assembly into a work surface, the feeder assembly mounted to the housing to translate along the drive axis relative to the fastener drive assembly; and
an adjustable depth selector carried between the housing and the feeder assembly to selectively adjust an allowable range of motion between the feeder assembly and the fastener drive assembly along the drive axis to control how deep the fastener in the feeder assembly can be driven into the work surface by the fastener drive assembly.

2. The powered fastening device of claim 1 wherein the adjustable depth selector comprises a rotatable selection knob positioned between the feeder assembly and the housing.

3. The powered fastening device of claim 2 wherein the rotatable selection knob comprises:
a first end in threaded engagement with the housing; and
a distal end that abuts the feeder assembly as the feeder assembly translates along the drive axis to limit the range of motion along the drive axis between the feeder assembly and the fastener drive assembly.

4. The powered fastening device of claim 3 wherein the first end is threaded into the housing.

5. The powered fastening device of claim 2 further comprising an elongate rail extending between the housing and the feeder assembly to mount the feeder assembly for translation along the drive axis relative to the fastener drive assembly, wherein the rotatable selection knob surrounds a portion of the elongate rail between the feeder assembly and the housing.

6. The powered fastening device of claim 1 wherein the motor is an electric motor.

7. The powered fastening device of claim 1 wherein the fastener drive assembly comprises a drive pin mounted to translate relative to the housing to strike a fastener positioned in the feeder assembly to drive the fastener into a work surface.

8. The powered fastening device of claim 7 wherein the motor is operably connected to the fastener drive assembly by a percussive assembly configured to strike the drive pin at regular intervals to drive the fastener into the work surface.

9. The powered fastening device of claim 8 wherein the percussive assembly comprises a hammer disk and an anvil element, the hammer disk and the anvil element mounted to rotate about a common axis, the hammer disk configured to transfer stored energy from a hammer spring to the anvil element, and the anvil element configured to transfer the stored energy to the drive pin.

10. The powered fastening device of claim 1 wherein the feeder assembly comprises:
a fastener magazine configured to carry the plurality of fasteners; and
a fastening nozzle configured to sequentially receive individual fasteners from the fastener magazine and to sequentially position each fastener relative to the fastener drive assembly to be driven into the work surface by the fastener drive assembly.

11. A powered fastening device comprising:
a housing;
a drive pin mounted to translate relative to the housing to repeatedly strike a fastener to drive the fastener into a work surface;
a drive motor carried in the housing and operably connected to the drive pin to actuate the drive pin to repeatedly strike the fastener to drive the fastener into the work surface;
a feeder assembly configured to carry a plurality of fasteners and to sequentially position each fastener of the plurality of fasteners relative to the drive pin to be driven by the drive pin into the work surface, the feeder assembly mounted to the housing to translate along the drive axis relative to the drive pin as the fastener is driven into the work surface; and
an adjustable depth selector carried between the housing and the feeder assembly to selectively adjust an allowable range of motion between the feeder assembly and the drive pin along the drive axis to control how deep the fastener in the feeder assembly can be driven into the work surface by the drive pin.

12. The powered fastening device of claim 11 wherein the adjustable depth selector comprises a rotatable selection knob positioned between the feeder assembly and the housing.

13. The powered fastening device of claim 12 wherein the rotatable selection knob comprises:
a first end in threaded engagement with the housing; and
a distal end that abuts the feeder assembly as the feeder assembly translates along the drive axis to limit the range of motion along the drive axis between the feeder assembly and the drive pin.

14. The powered fastening device of claim 13 wherein the first end is threaded into the housing.

15. The powered fastening device of claim 12 further comprising an elongate rail extending between the housing and the feeder assembly to mount the feeder assembly for translation along the drive axis relative to the drive pin, wherein the rotatable selection knob surrounds a portion of the elongate rail between the feeder assembly and the housing.

16. The powered fastening device of claim 11 wherein the motor is an electric motor.

17. The powered fastening device of claim 11 wherein the motor is operably connected to the drive pin by a percussive assembly configured to strike the drive pin at regular intervals to drive the fastener into the work surface.

18. The powered fastening device of claim 17 wherein the percussive assembly comprises a hammer disk and an anvil element, the hammer disk and the anvil element mounted to rotate about a common axis, the hammer disk configured to transfer stored energy from a hammer spring to the anvil element, and the anvil element configured to transfer the stored energy to the drive pin.

19. The powered fastening device of claim 11 wherein the drive pin is carried in a fastener drive assembly mounted in the housing.

20. The powered fastening device of claim 11 wherein the feeder assembly comprises:
a fastener magazine configured to carry the plurality of fasteners; and
a fastening nozzle configured to sequentially receive individual fasteners from the fastener magazine and to sequentially position each fastener relative to the drive pin to be driven into the work surface by the drive pin.
